(19) United States
(12) Patent Application Publication
(10) Pub. No.: US 2026/0214370 A1
(43) Pub. Date: Jul. 23, 2026

(54) HEATED EARBUDS

(71) Applicant: Tempo Technologies LLC, Seattle, WA (US)

(72) Inventors: Peter Leonard, Seattle, WA (US); Tyler Evans, Littleton, CO (US)

(21) Appl. No.: 19/453,145

(22) Filed: Jan. 20, 2026

Related U.S. Application Data
(60) Provisional application No. 63/752,342, filed on Jan. 31, 2025.
(60) Provisional application No. 63/748,401, filed on Jan. 22, 2025.

(51) Int. Cl. H04R 1/10; H05B 6/06; H05B 6/10; H05B 6/36

(52) U.S. Cl. CPC H04R 1/1041; H04R 1/1016; H04R 1/1091; H05B 6/06; H05B 6/10; H05B 6/36; H04R 2420/07

(57) ABSTRACT

An earbud system and related devices and methods are described herein to provide comfort heating or cooling via an earbud tip to an outer portion of an ear canal of the wearer. Earbuds of the system include a driver for providing audio to the ear canal. The thermal system is quiet so that audio can be comfortably enjoyed by the wearer while heating or cooling is simultaneously applied.

### CROSS-REFERENCE TO RELATED APPLICATIONS

The present application claims priority to U.S. Provisional Patent Application No. 63/748,401 filed January 22, 2025 and U.S. Provisional Patent Application No. 63/752,342 filed January 31, 2025, the entire contents of each of which are incorporated by reference herein.

### BACKGROUND

Earbuds are a very common way for people to listen to music, podcasts, audiobooks, or participate in mobile phone calls. Many people have their earbuds continuously in their ears for a prolonged period of time, especially while running or engaging in other athletic activities.

Separately, and less commonly, earbuds may be configured for therapeutic purposes. For instance, one earbud system is described as blowing heated air into the inner ear to dry it and heat it by way of convection. However, the flow of heated air may cause user discomfort, and temperature control can be challenging, which can create a safety issue given that the ear may take time to cool down once heated by air. Therapeutic earbuds do not provide audio. Further, when convection is used, the noise from air essentially prohibits modification of the therapeutic earbuds to provide audio output.

### SUMMARY

Applicants recognize a need to provide an audio system having an in-ear device which is capable of providing comfortable audio output and ear temperature monitoring and/or control.

### BRIEF DESCRIPTION OF THE DRAWINGS

While the specification concludes with claims, which particularly point out and distinctly claim the subject matter described herein, it is believed the subject matter will be better understood from the following description of certain examples taken in conjunction with the accompanying drawings, in which like reference numerals identify the same elements. The figures depict one or more implementations of the inventive devices, by way of example only, not by way of limitation.

FIG. 1 is an illustration of a first example earbud system in accordance with an embodiment of the invention.

FIG. 2 is an illustration of a second example earbud system in accordance with an embodiment of the invention.

FIG. 3 is an illustration of a third example earbud system in accordance with an embodiment of the invention.

FIG. 4 is an illustration of a fourth example earbud system in accordance with an embodiment of the invention.

FIG. 5 is an illustration of a fifth example earbud system in accordance with an embodiment of the invention.

FIG. 6 is an illustration of a sixth example earbud system in accordance with an embodiment of the invention.

FIG. 7 is a flow diagram of a method in accordance with an embodiment of the invention.

FIG. 8 is an illustration of an example earbud assembly in accordance with an embodiment of the invention.

FIG. 9 is an illustration of an example hearing aid in accordance with an embodiment of the invention.

### DETAILED DESCRIPTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. To the extent that any materials incorporated by reference herein contain similar terms but differ in definition or description, it will be appreciated that the definitions and descriptions provided herein are to be used in understanding the technology disclosed herein.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g. “about 90%” may refer to the range of values from 71% to 110%.

As used herein, the term “earbud” includes auditory devices configured such that, when worn properly, at least a portion of the housing containing the driver is positioned at or within the aperture of the ear canal, including intraconcha and intracanal positions. The term “earbud” broadly encompasses devices which are configured to fit snugly within the ear canal creating a seal and devices which do not seal the ear canal. The term “earbud” excludes over-ear headphones (circumaural) and on-ear headphones (supra-aural) which are designed to be positioned against or surround portions of the ear perimeter such as the helix or lobe when worn.

As used herein, the terms “earbud tip” and “ear tip” are used interchangeably to refer to a component of an intracanal earbud configured to be worn within the ear canal. The earbud tip is configured to at least partially conform to the ear canal, preferably creating a seal.

An object of the present invention is to provide heated earbuds that transmit heat to the inner ear by way of conduction.

Another object of the present invention is to provide heated earbuds that can provide heat and sound at the same time.

Another object of the present invention is to provide heated earbuds whose temperature is easy to control precisely.

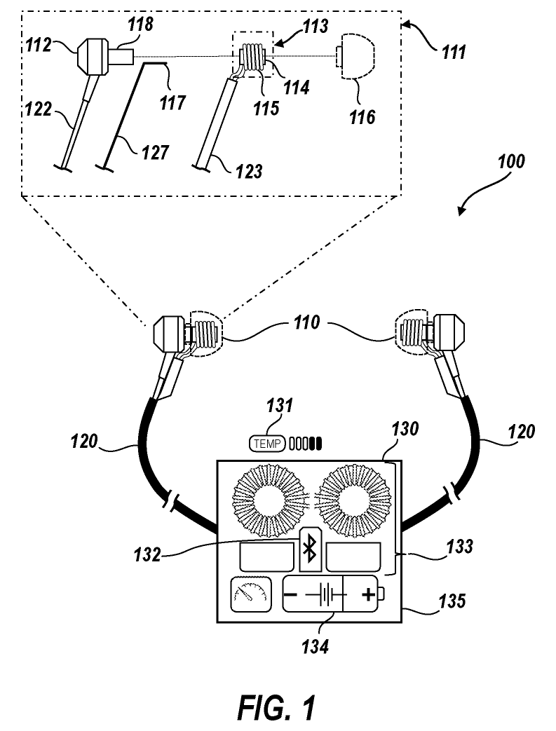

FIG. 1 is an illustration of a first example earbud system 100. As shown, a pair of wired earbuds 110 are provided in which audio and power for heating are transmitted via wires 120. Additionally, or alternatively, power for heating can be transmitted via wires 120 while audio data is transmitted wirelessly. The pair of earbuds 110 may include two earbud assemblies 111. Each earbud assembly 111 can include a heating element 113 which can include a ferrous metal tube 114 and an induction coil 115 wrapped around the ferrous metal tube 114, as shown in FIG. 1. Optionally, each earbud assembly 111 can include a plastic protrusion 118 around which the heating element 113 (e.g., ferrous metal tube 114) can fit. The plastic protrusion 118 can be part of a rigid earbud housing 112. A heat-conductive flexible earbud tip 116 then fits around the heating element 113 (e.g., induction coil 115), conducting heat from the heating element 113 (e.g., ferrous metal tube 114) to the user's ear. The heat-conductive earbud tip 116 may be made of silicone or other suitable, preferably flexible, heat-conductive elastomers, or other heat-conductive flexible material to facilitate efficient heat transfer from the heating element 113 to the earbud tip 116.

The heating of the ear by the earbud assembly may therefore utilize induction. The induction coil 115 can create an oscillating magnetic field when alternating current is passed through it, which can heat the tube element 114. The tube element 114 can be practically made of ferrous metal because that class of metals is most receptive and responsive to inductive currents, but the induction tube 114 could also be made of a wide variety of alternative materials — so long as the material is responsive to an induction current. Other potential materials could include: ferrous metals: iron, steel, and stainless steel, non-ferrous metals: aluminum, copper, brass, zinc, tungsten, chrome, nickel, cobalt, platinum, silver, and gold, semiconductors: silicon carbide, carbon, and graphite, or it could also include non-conductive materials like glass or plastic by heating an electrically conductive susceptor, like graphite, which then transfers heat to the non-conductive material.

The temperature of the ferrous metal tube 114 can be easy to control and can be adjusted instantly (or limited by design for safety). As shown in FIG. 1, a temperature sensor 117 is preferably included in the earbud assembly 111 to allow for precise temperature control. The heating can be produced quietly (as opposed to the prior art hot-air devices), meaning that the example earbud system 100 could deliver heat and audio at the same time, without interfering or creating competing noise with the audio sounds.

The heating element 113 (e.g., induction coil 115) can receive power via heating element connector(s) 123, which may include a pair of low-inductance braided/twisted "Litz wires", as shown in FIG. 1. Litz wires are a multi-strand wire used in electronics to carry alternating current at radio frequencies, intended to reduce induction losses over long distances; each individual filament is individually insulated and twisted or braided in a unique pattern that confounds the signals/inductances against each other, allowing high-frequency alternating signals to be transmitted over significant distances with much less loss. The heating element connector(s) 123 (e.g., Litz wires) can be bundled together with an audio signal cable 122 in the wires 120 as shown. This allows the driver circuit for the heating element 113 to be separate and a significant distance from the earbuds, and allows the actual earbud coils 115 to be small enough to fit into the ear. A design including Litz wires may have advantages over an alternative design which utilizes a heating element 113 including an inductive coil 115 and ferrous tube 114 but no Litz wires.

Without the Litz wires, the inductance driver circuit may need to be co-located with or near the earbud, which may make the size of each earbud assembly 111 prohibitively large, and the earbud coils 115 may be much larger to provide enough inductance to sufficiently heat the ferrous metal tube 114. The alternative design may consume or waste significantly more energy than the illustrated embodiment, which may greatly penalize the battery life. Any one of these aforementioned drawbacks of the alternative design may make the earbuds impractical to use.

Each heating element 113 (e.g., induction coil 115) can be connected to a control module 130 via the heating element connectors 123 (e.g., Litz wires) as shown in FIG. 1. In an embodiment, the Litz wire itself creates the coil 115, such that the entire transmission from the control module 130 to the earbud assembly 111 around the ferrous metal tube 114, and back, consists entirely of Litz wire. Using Litz wire for the entire transmission and coil 115 may enable fewer connections and simplifies the design. The control module 130 can include a temperature control interface 131, a temperature control module (within control module 130 and controlled by temperature control interface 131), an audio receiver 132 (e.g., Bluetooth transceiver as shown in FIG. 1, or other suitable audio receiver), a heating element driver circuit 133 (e.g., zero voltage switching driver (ZVS), or similar DC-to-AC converter or induction circuit), or combination thereof. A power source 134 (e.g., DC voltage source, such as a battery) can be used to provide energy to the system 100. A wide range of additional or alternative power options can be used, such as solar, kinetic, AC, power adapter that converts AC current to DC, power capacitors, wireless, power over ethernet, thermal gradient, thermoelectric generator, etc.

The ferrous metal tube 114 may include a suitable ferrous metal that can be heated using induction such as 22 gauge mild steel. However, other suitable induction-sensitive material may also be used, such as stainless steel, iron, and so on as described herein or otherwise understood by a person skilled in the art. The thickness of the ferrous metal tube may be relatively immaterial to the design, and may affect how much residual heat is retained in the metal. FIG. 1 shows a hollow ferrous metal tube 114 that fits around a plastic protrusion 118 similar to as found in standard earbuds. Additionally or alternatively, the ferrous metal element 114 can include a solid rod. The ferrous metal element 114 will be referred to as a "tube" for convenience in the present disclosure.

The induction coil 115 preferably includes six coils of small-gauge wire or Litz wire, though other suitable number of coils may be used for practicing the present invention. In one embodiment, the induction coil 115 includes only a single coil capable of inducing sufficient heat in the ferrous metal element 114. Alternatively, the induction coil 115 can include a plurality of coils (e.g., turns). Increasing the number of coils may increase the exposure of the ferrous metal tube 114 to the magnetic field, but may also increase the inductance. In practice, the number of coils can be determined (e.g., optimized) in relation to the characteristics of the overall circuit. Furthermore, the induction coil 115 could be arranged in a "cylindrical pattern" around a tube or rod, or the induction coil could be arranged in a "spiral pattern" facing a flat or curved surface.

In an embodiment, the induction coil 115 can be located at another position in the earbud assembly 111, further away from the ear, and used to heat up some components already present in the earbud (such as the audio speaker frame). Such components can be configured to be heated without impacting the function of the component. Component count and earbud size can potentially be reduced by using components that provide heating as well as other functionality within the earbud assembly 111.

In an embodiment, the earbud assembly 111 can include a temperature sensor 117 such as a K-type thermocouple or other suitable type of temperature sensing or temperature feedback method as shown in FIG. 1. The temperature sensor 117 can be configured to provide instant feedback on the temperature of the earbud, which may allow easy control of the temperature and an easy way to limit heating to safe levels. Temperature sensors having a suitable form factor and temperature measurement capabilities may be included in the earbud assembly 111. The temperature sensor 117 can connect to the control module 130 via a thermal sensor cable 127.

In addition, or as an alternative to, including a temperature sensor 117 in the earbud assembly 111 for temperature sensing and control, inductive signal characteristics and prior testing data can be used to estimate temperature and/or provide temperature control to achieve a target temperature. For instance, sufficient prior testing can be performed to correlate inductive signal characteristics, such as voltage, current, alternating frequency, duty-cycle, etc., to a safe and comfortable temperature, and the control module 130 (e.g., heating element driver circuit 133) can be programmed or designed to not exceed the magnitude of that inductive signal. The control module 130 can include a processor and non-transitory computer-readable medium storing instructions thereon that when executed by the processor cause the heating element driver circuit 133 to provide an inductive signal having characteristics that are based at least in part on the prior testing data to achieve the target temperature.

In an embodiment, the control module 130 can include a housing 135 (e.g., mobile phone attachment accessory or case accessory) and the entire heating element driver circuit 133 (e.g., induction circuitry) and control circuitry can be contained in the housing 135. The control module can include a connection port (e.g., modified headphone jack or data jack) configured connect both the audio signal and the induction signal. The control module 130, when configured as a mobile phone accessory can be configured to connect directly to a phone's audio via a cable jack (lightning, USB-C, or any other common connector type). Additionally, or alternatively, the control module 130 can be configured to connect to the phone via Bluetooth, Wi-Fi, or other suitable wireless protocol.

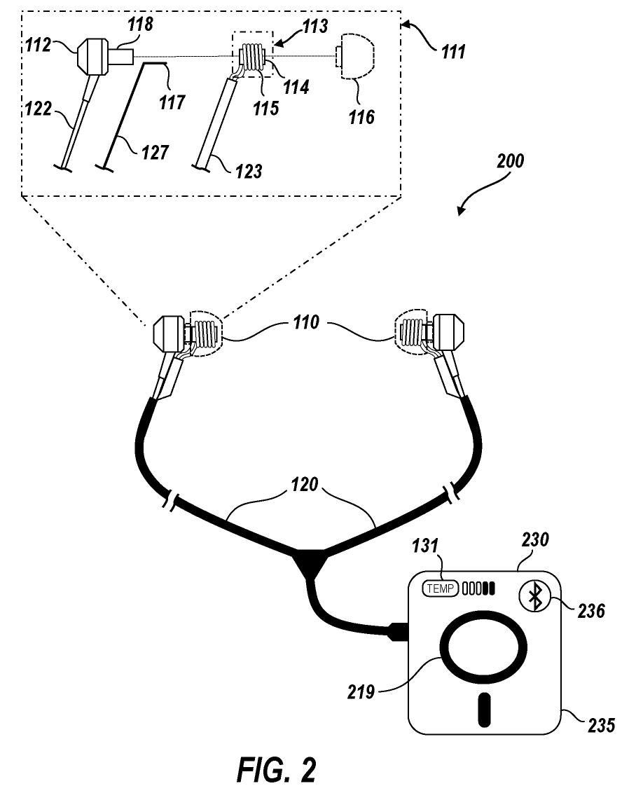

FIG. 2 is an illustration of a second example earbud system 200 which includes a control module 230 including a wireless mobile phone charging device (wireless power bank) 219, so that the heated earbuds system 200 is capable of using an onboard power source (e.g., battery) to generate a wireless induction signal to charge the battery of a mobile phone (such as the QiTM or other similar wireless charging standard) and/or the same device is capable of using the same onboard power source to separately and/or simultaneously generate an induction signal of similar or different characteristics, for the purpose of delivering an induction heating signal to the earbuds (e.g., earbud assembly 111). Additionally, or alternatively, the control module 230 can include a wired backup battery configured to charge external devices via wired connection such as USB. The control module 230 preferably has a housing 235 sized, shaped, and otherwise configured comparable to a portable external battery.

The heated earbuds (e.g., heated earbuds systems 200) can be integrated with the mobile phone charging device (e.g., integrated with control module 230). The earbuds (e.g., heated earbuds system 200) can include Litz wire cables (e.g., as part of heating element connectors 123 of wires 120) that are either permanently attached to the voltage source of the control module 230 (e.g., battery pack) and heating element driver circuit 133 (FIG. 1, e.g., induction circuit unit), or the Litz wire cables can detachably plug into the voltage source of the control module 230 (e.g., battery pack) and heating element driver circuit 133 (FIG. 1, e.g., induction circuit) unit via an electrical connector or jack, similar to traditional wired headphone jacks. In this embodiment, the earbuds (e.g., heated earbuds system 200) can be configured to receive their audio signal wirelessly or through a wired connection, via a plurality of options (including, but not limited to, a radio receiver chip or auxiliary cable).

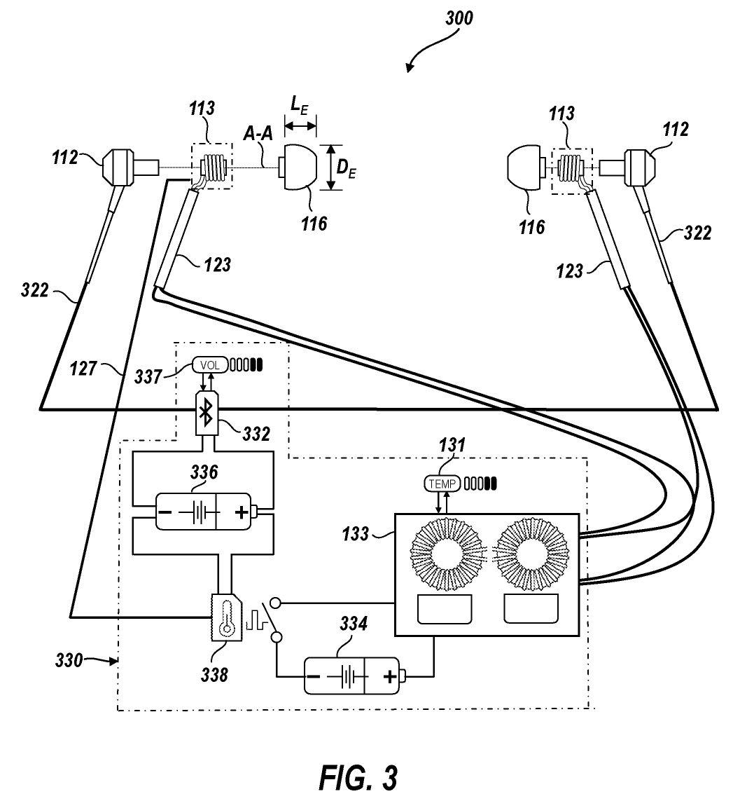

FIG. 3 is an illustration of a third example earbud system 300 in which a simplified electrical diagram of the system 300 illustrated. The control system 330 can include heating element driver circuit 133 which has a dedicated power source 334. The control system 330 can have a sensor feedback controller 338 which can switch the power source 334 to the heating element driver circuit 133 to maintain the heating element 113 and earbud tip 116 at a target temperature or within a target temperature range. The sensor feedback controller 338 can receive sensor data from the thermal sensor 117, alternative sensor, or combinations of sensors for controlling connection of the power source 334 to the heating element driver circuit 133. The control system 330 can include a secondary power source 336 configured to power a receiver 332 and the sensor feedback controller 338. The receiver 332 and audio control interface 337 (e.g., volume control) can be coupled to the audio signal cable 322.

Another application for the earbud systems presented herein, variations thereof, or alternatives thereto as understood by a person skilled in the art, can be to provide a practical means to accurately and frequently measure the inner-ear temperature of the user. The temperature sensor 117 can be positioned within the earbud assembly 111 so that it is configured to sense temperature within in the inner ear when the earbuds 110 are worn by a user. The system can include a conduction-based heater 113 with an integrated temperature sensor 117. The heater 113 with integrated temperature sensor 117 can be used as a direct contact temperature sensor when it is not delivering heat (e.g., the heating element 113 is unpowered). Because body temperature is highly relevant to a wide variety of health conditions, it is very beneficial for users to have access to an accurate and continuous body temperature measure. Many fitness trackers and smartwatches sample wrist temperature for this purpose, but taking body temperature measurements from the exterior surface of the skin is far less accurate than inner ear temperature. Thus, in one embodiment of the present invention, the temperature sensor in the earbuds is used to measure inner ear temperature when the earbuds are not heated; the data is then transmitted (e.g., via a transceiver of the earbuds system 300) to the user's smartphone or other device, to be available for use, as permitted by the user, by any number of software applications.

A cooling device may be connected to the earbud, so that the earbud may deliver either heat or cold (or just cold) to the ear. The cooling device may be any conductive cooling device that is thermally connected to the earphones and that does not emit sounds that interfere with the audio provided by the earphones, for example a Thermal Electric Generator (TEG). The heating element 113 can therefore be a thermal element 113 which is configured for heating, cooling, or both.

To ensure optimal user experience and high-fidelity audio output, the thermal element is preferably engineered to operate with minimal acoustic emissions. In particular, the thermal element is configured such that any noise generated during operation—including mechanical vibrations, electromagnetic interference, or other audible artifacts—is maintained at a level that is inaudible or negligible to the user during typical audio playback. For example, the heating element noise at the ear canal is desirably less than 30 dBA sound pressure level (SPL), which is at least 10 decibels below the quietest passages of typical audio content. This threshold ensures that heating-related noise does not interfere with or detract from the perceived quality of music, speech, or other audio signals delivered by the earbud speaker. Additionally, the heating element is preferably designed to avoid generating noise within the frequency range most sensitive to human hearing (approximately 1 kHz to 5 kHz), further minimizing the potential for perceptible interference. In some embodiments, the control circuitry may actively modulate heating operation to suppress transient or steady-state noise, thereby maintaining a clear and uninterrupted audio experience for the user.

In some embodiments, the thermal element can include a resistive heating element, a positive temperature coefficient heating element, a thermoelectric heating element, or other suitable heating element in addition to, or as an alternative to the inductive heating element illustrated herein. The principles of temperature feedback control describe herein can be applied to alternative heating element components and cooling elements. In embodiments incorporating a feedback loop, heating can be controllable to a precise temperature or small range of temperatures rather than just low-med-hi setting.

For instance, the temperature sensor 117 can be configured to provide feedback to a control circuit to cause the heating element driver circuit 133 to provide an output signal which is adjusted based at least in part on the temperature sensed by the temperature sensor 117. Additionally, or alternatively, prior testing may be performed which maps the output signal of the heating element driver circuit 133 to an expected temperature, or range of temperatures, of the earbuds are a result of heating of the heating element; and the control circuit can be configured to cause the heating element driver circuit 133 to provide an output signal based on a user-selection of a temperature or range of temperatures.

In embodiments without a temperature sensor, alternative temperature control feedback mechanisms may be utilized such as characterizing a feature of the output signal such as power consumption, frequency response, etc. Such characterizations may be mapped to expected temperatures of the earbuds through prior testing, and the output signal may be adjusted based on a comparison of the characterizations to prior testing feedback. For instance, ambient temperature may affect expected earbud temperature and characteristics of the output signal, and such feedback can be configured to adjust the output signal to account for ambient temperature without relying on a temperature sensor. For embodiments including an inductive heating source, inductive signal characteristics and prior testing data can be used to estimate temperature and/or provide temperature control to achieve a target temperature as described herein. For embodiments including a positive temperature coefficient heating element, testing can be performed to map resistance of a positive temperature coefficient heating element to temperature of the portion of the earbud assembly configured to be in contact with the wearer.

In some embodiments, the heating element 113 can include or be replaced by a cooling element. For instance, the earbud assembly 111 may include one or more thermoelectric elements which can provide cooling, heating, or alternate between cooling and heating.

The earbud assembly 111 is drawn as an intracanal in-ear audio device. Alternatively, the earbud assembly can include an in-ear audio device having a rigid earbud body configured to be positioned intraconcha. Aspects of any of the in-ear audio devices illustrated herein and their respective rigid earbud body alternative embodiments can be applied to other in-ear audio devices having intracanal or intraconcha portions such as hearing aids.

Such in-ear audio device can include an acoustic transducer, an audio port, an acoustic channel, an intraconcha or intracanal portion, and a thermal element. The acoustic transducer can include a driver in the context of earbuds, a receiver in the context of hearing aids, or other component configured to provide audio in other in-ear audio device contexts. The audio port can include an opening in the earbud body in the context of earbuds, or other opening configured to direct audio output in other in-ear audio device contexts. The acoustic channel can include an audio pathway configured to deliver sound from the driver to the opening of the earbud body in the context of earbuds, or other fluidic passageway configured for acoustic conduction from the acoustic transducer to the audio port in other in-ear audio device contexts. The intraconcha or intracanal portion can include an intracanal portion of an earbud tip and/or an intraconcha portion of an earbud body in the context of earbuds, or other such structure configured to be positioned in or adjacent to the ear canal in other in-ear audio device contexts. The thermal element can be configured to be driven to control a temperature of an outer surface of the intraconcha or intracanal portion of the in-ear audio device.

Heat can be transferred between the in-ear audio device and an ear canal and/or portion of the outer ear near the aperture of the ear canal (e.g., concha cava) primarily via conductive heating due to physical contact between intracanal and/or intraconcha portions of the earbud assembly and skin. Heat can be transferred between the heating element and intracanal and/or intraconcha portions by conductive heating due to direct physical contact between said portions and heating element or physical connection of thermally conductive materials between the heating element and said portions.

The thermal energy delivered to the ear via the in-ear audio devices may be quantitatively described by the power output of the thermal element—whether configured for heating or cooling—typically between 0.1 and 1.0 Watts. The temperature of the contact surface of the in-ear audio device is preferably maintained within a safe and comfortable range, for example, less than 45 °C between 35 °C and 42 °C for heating, or between 15 °C and 3 5°C for cooling, depending on user preference and safety guidelines. In some embodiments, the contact surface can be maintained at approximately body temperature, preferably 36 °C to 38 °C. The heat flux or cooling flux at the interface between the contact surface and the ear canal may be in the range of 0.05 to 0.2 W/cm². The in-ear audio device can be configured to transfer thermal energy primarily by conduction, with thermal conductance determined by the material properties and geometry of the intraconcha and/or intracanal portion. Power output of the thermal element, heat/cooling flux, and thermal properties of the earbud assembly can affect the temperature of the contact surface based on the design of the earbud assembly and use conditions. Feedback control can be used to obtain a desired contact temperature.

In some embodiments, real-time temperature monitoring and feedback control may be employed, utilizing temperature sensors or signal mapping to dynamically adjust the power output and maintain the earbud tip within the desired temperature range, thereby ensuring user safety and comfort. In some embodiments, the system may further regulate the duration and intensity of heating or cooling to ensure that the total energy delivered does not exceed safe exposure limits for ear canal tissue.

In embodiments which include wireless communication capabilities, in addition, or as an alternative to utilizing wireless communication for audio transmission, the wireless communication can further be utilized for temperature control, temperature data collection, or combination thereof.

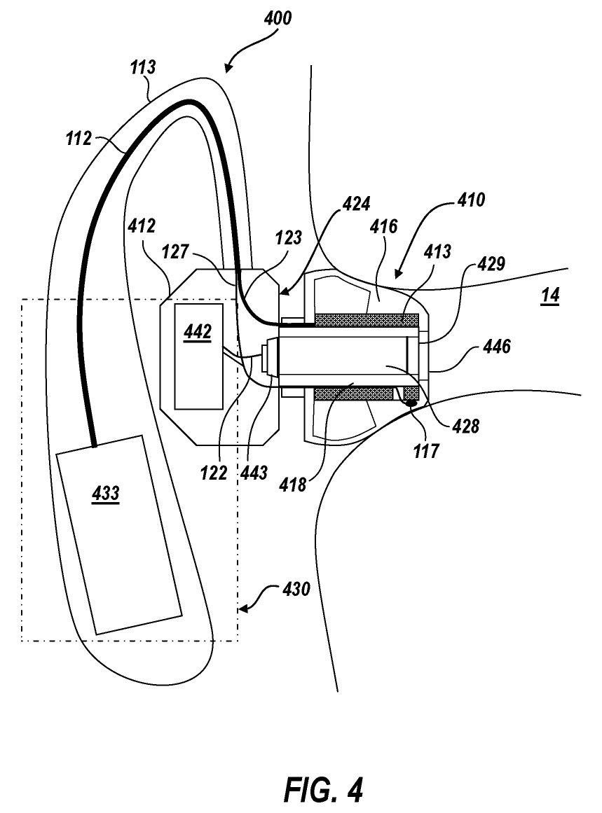

FIG. 4 is an illustration of a fourth example earbud system 400 in which the entire system is configured to be worn on the head of the wearer, for instance as an over-ear earbud as illustrated. FIG. 4 also illustrates several internal mechanisms of the earbud 410. Compatible aspects of the earbud system 400 can be adapted for alternative in-ear audio devices described herein, variations thereof, or alternatives thereto as understood by a person skilled in the art.

As illustrated, the earbud system 400 can include a driver 443, an earbud body 424 containing the driver 443, and an audio pathway 428 configured to deliver sound from the driver 443 toward a distal end 429 of the earbud body 424. As illustrated, the earbud body 242 can include an outer portion 412 configured to be positioned outside of the canal 14 and a hollow tube 418 configured to extend into the canal 14 when worn. The hollow interior of the hollow tube 418 can define the audio pathway 428.

The earbud system 400 can include a flexible earbud tip 416 coupled to the earbud body 424. The flexible earbud tip 416 can have a distal, or inner, end 446 which provides an atraumatic cover to the end 429 of the earbud body 424 and includes an opening coinciding with the audio pathway 428. As illustrated, the flexible earbud tip can be configured to conform to the aperture and a portion of the ear canal to form a seal resulting in a sealed volume within the ear canal 14. The earbud system 400 can include a thermal element 413 (e.g., heating element) positioned in thermal communication with the flexible earbud tip 416. As illustrated, the thermal element 413 can be in direct contact with the flexible earbud tip 416 or otherwise in thermal communication with the flexible earbud tip 416 so that heat flows via conduction between the thermal element 413 and the flexible earbud tip 416.

Other earbud embodiments presented herein also can include a driver, earbud body, audio pathway, flexible earbud tip, and heating element as shown in FIG. 4.

The thermal element 413 can include a tubular or cuff shape which circumscribes a majority of a circumference of the audio pathway 428.

The flexible earbud tip 416 can have a radially symmetrical shape when unconstrained. See, for example, the shape of earbud tip 116 in FIGS. 1-3. Configured as such, the combination of the thermal element 413 and flexible earbud tip can provide a uniform temperature around a circumference of the flexible earbud tip 416. The flexible earbud tip 416 can have an outer contact surface forming convex surface of revolution about an axis (e.g., central axis of the audio pathway). As illustrated, this flexible earbud tip 416 can be configured to deform when positioned within a canal comprising a proximal funnel opening such as ear canal 14. The outer contact surface can be configured to conform to a proximal portion of the canal 14.

The flexible earbud tip 416 outer contact surface can have dimensions similar to flexible earbud tips of consumer earbud tips. The outer contact surface can have a diameter of 8 to 18 mm (or more commonly 10 to 15 mm) as measured across the widest portion of the outer contact surface orthogonal to the axis of revolution, and a length, as measured along the axis of revolution of 6 to 15 mm (or more commonly 8 to 12 mm). The flexible earbud tip 416 can include a multiple flange design having more than one convex outer surfaces of revolution about an axis, resulting in a longer length of 15 mm to 22 mm. The diameter D_{E} and length L_{E} of the earbud tip can be measured with respect to axis A-A as illustrated in FIG. 3.

As an alternative to the flexible earbud tip 416, the earbud 410 can be modified as an alternative in-ear device having an intraconcha or intracanal portion with an outer surface configured to make contact with skin of the inner and/or outer ear within or adjacent the ear canal when worn, and the thermal element 413

As illustrated, the thermal element 413 can include a resistive heating element. The thermal element 413 may include additional or alternative thermal elements such as those described in other embodiments herein, variations thereof, or alternatives thereto as understood by a person skilled in the art. Temperature sensor 117 can be mounted on or adjacent to the thermal element 413 to measure temperature at a location such that sensor data from the temperature sensor 117 is indicative of temperature at an interface between a contact surface of the flexible earbud tip 416 and skin. Additionally, or alternatively, the thermal element 413 can include temperature sensor 117. For instance, the thermal element 413 and temperature sensor 117 can be separate elements integrated on a single flexible circuit. As another example, the thermal element 413 can include a positive temperature coefficient heating element which can function as a temperature sensor 117.

The control module 430 can include a thermal element controller 433 and a secondary or audio controller 442. The thermal element controller 433 can include a thermal driver circuit (e.g., heating element driver circuit) and a power source (e.g., battery) and can be in electrical communication with the thermal element 413 via wires or connectors 123. The thermal driver circuit can be configured to generate a control signal for operating the thermal element 413. The secondary or audio controller 442 can include an audio driver circuit configured to output an electrical audio signal to the driver 443. The audio controller 442 can include a power source independent of the power source of the thermal element controller 433 so that the earbud system 400 can continue to provide audio when the thermal driver circuit power source is depleted but the audio controller power source is not, and vice versa.

The control module 430 can further include a temperature control circuit which can be integrated with the thermal element controller 433, secondary controller 442, or distributed across both controllers 433, 442. The temperature control circuit can determine a target temperature or range of temperatures. The determination may be made based on a user selection at a user interface (e.g., interface 131 in FIG. 1), based on sensor data, based on heating time, based on delivered energy through heat, or combination thereof. The temperature control circuit may be configured to receive signals from the temperature sensor 117. The temperature control circuit, or separate circuit may be configured to transmit temperature data to an external device which is external to the earbud system 400.

Other earbud embodiments presented herein also can include control module which includes a separate thermal element controller and secondary or audio controller as described in relation to FIG. 4. The control module of embodiments herein can include additional control circuits.

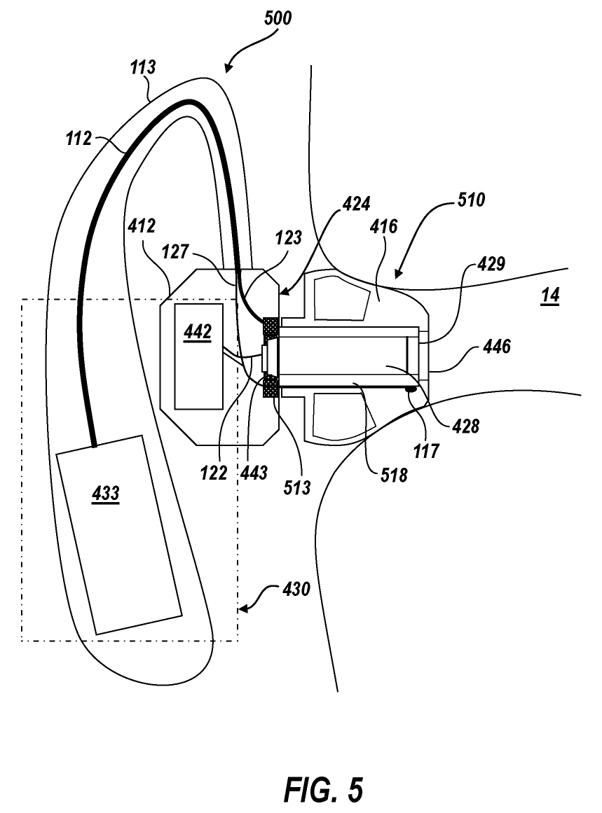

FIG. 5 is an illustration of a fifth example earbud system 500 which includes an alternative thermal element configuration. As illustrated, the earbud 510 can include a heating element 513 which is not in direct contact with the flexible earbud tip 416, but is in thermal communication with the earbud tip 416 via a thermal conduit. As illustrated, the nozzle 518 can include thermally conductive material (e.g., metal) and can be in direct contact with the thermal element 513 and flexible earbud tip 416 to provide thermal communication between the thermal element 513 and flexible earbud tip 416.

Compatible aspects of the earbud system 500 can be adapted for alternative in-ear audio devices described herein, variations thereof, or alternatives thereto as understood by a person skilled in the art.

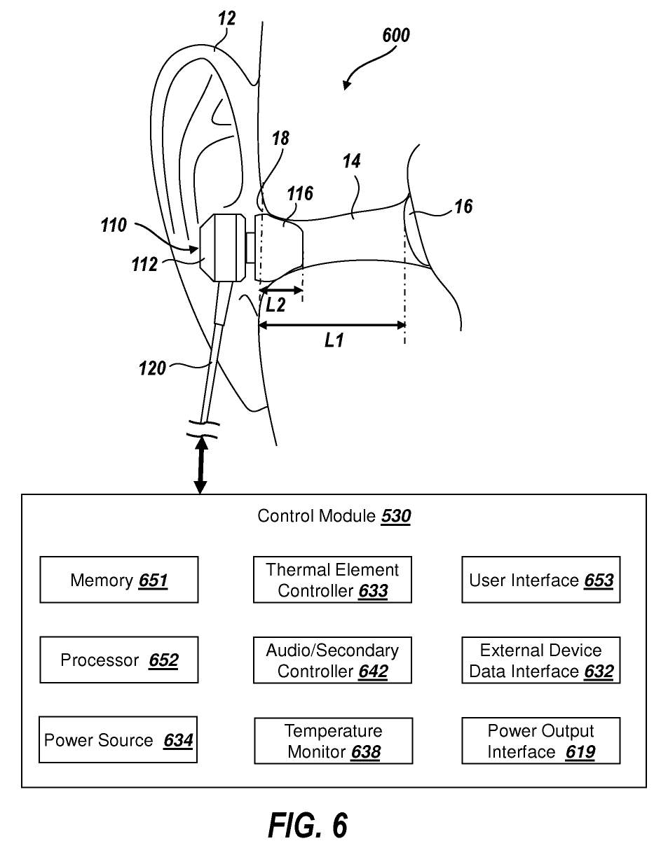

FIG. 6 is an illustration of a sixth example earbud system 600 which shows a preferred position of the earbud 110 when worn and functional blocks of the control module 630.

The illustrated earbud 110 can include compatible features of earbuds of other embodiments illustrated herein, variations thereof, or alternatives thereto as understood by a person skilled in the art. Likewise, earbud embodiments shown and described herein can have a flexible earbud tip 116 sized, shaped, and otherwise configured as described in relation to FIG. 6. The flexible earbud tip 116 preferably extends a length L2, as measured from a plane 18 defined by the ear aperture (e.g., funnel opening of canal 14), to the end of the flexible earbud tip, of between 8 and 15 millimeters (mm). The flexible earbud tip 116 preferably shaped so that it cannot be inserted by length L2 more than 15 mm. The earbud tip 116 preferably shaped to comfortably fit length L2 within the canal 14 which is less than half a total length L1 of the ear canal as measured from the plane 18 at the aperture to the eardrum 16.

The control module 630 is illustrated as including several functional blocks. Combinations of functional blocks may be integrated into the same circuit or circuit board, or can be distributed between different circuits or circuit boards.

The control module 630 can include processor(s) 652 and memory 651 with instructions that when executed by the processor(s) 652 to control the earbuds system 600. The earbud system 600 in FIG. 6 and other example earbud system herein can include memory that is consolidated on a single chip or circuit board or distributed over multiple chips or circuit boards. The memory can include non-transitory computer-readable medium. The system 600 can include one processor 652 or multiple processors 652. Memory 651, its instructions, and processor 652 may be distributed among, and separately integrated with various circuits (e.g., functional blocks). The instructions can be executed by processor(s) 652 to cause the control module 630 to perform steps which achieve functionality of the functional blocks and computational method steps, including steps of method 700.

The control module can include a power source 634, which can be a single power source, or can include multiple power sources. Additionally, or alternatively, the control module 630 can be configured to receive power from an external power source, e.g., via a wired powered connection port to a mobile phone or computer such as a USB port.

The control module 630 can include a thermal element controller 633, which can have the functionality of thermal element controllers 133, 433 described herein, variations thereof, or alternatives thereto as understood by a person skilled in the art.

The control module 630 can include an audio or secondary controller 642, which can have the functionality of audio/secondary controllers 442, components thereof (e.g., elements 332, 338), variations thereof, or alternatives thereto as understood by a person skilled in the art.

The control module 630 can include a temperature monitor 638 configured to provide temperature data indicative of inner-ear temperature of the wearer. The temperature monitor can be configured as described elsewhere herein, variations thereof, or alternatives thereto as understood by a person skilled in the art.

The control module can include a user interface 653 configured to receive user input for temperature and/or audio control, or otherwise have functionality of user interfaces 131, 236, 332, 337, illustrated herein, user interfaces described herein, variations thereof, or alternatives thereto as understood by a person skilled in the art.

The control module can include an external device data interface 632, which can have the functionality of data interfaces 132, 332, illustrated or described herein, variations thereof, or alternatives thereto as understood by a person skilled in the art. The data interfaces can be configured to receive and/or send data between the earbuds system 600 and a device external to the earbuds system such as a mobile phone or computer. For instance, the external device data interface 632 can be configured to receive audio signal data, transmit sensor data, or combination thereof.

The control module can include a power output interface 619 which can have the functionality of charging device 219, variations thereof, or alternatives thereto as understood by a person skilled in the art.

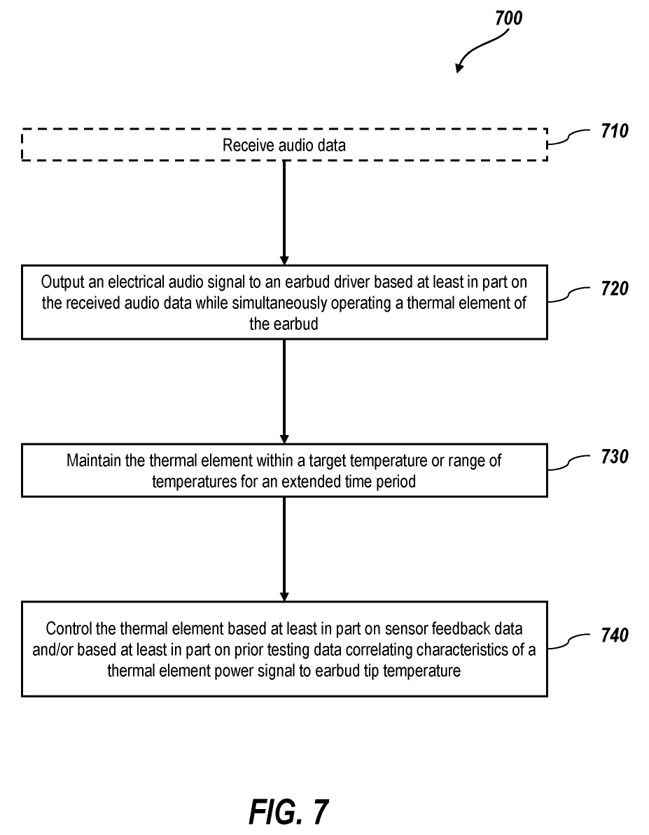

FIG. 7 is a flow diagram of a method 700 which can be performed by an earbud system or a control module for controlling an earbud assembly having a driver and a thermal element.

At optional block 710, audio data can be received from an external device such as a mobile phone or a computer. The audio data can be received wirelessly or via audio cable.

At block 720, an electrical audio signal can be output to the driver based at least in part on the audio data. The audio data can be converted from a wireless data signal to an electrical audio signal, or the audio data itself can include the electrical audio signal and can be passed through to the driver. The audio data may be altered (e.g., with insertion of alerts associated with the earbud system).

At block 730, the thermal element can be maintained at a target temperature or within a range of temperatures for an extended period of time. For instance, the thermal element can be maintained within a temperature range between 35°C and 45°C for at least 30 minutes, or more preferably at least an hour. More preferably, the thermal element can be maintained between 35 °C and 42 °C for heating, between 15 °C and 35°C for cooling, or at approximately body temperature, preferably 36 °C to 38 °C. The method can include maintaining a target temperature or range of temperatures for one of: heating, cooling, or maintaining body temperature for a first period of time of at least 30 minutes and later maintaining a target temperature or range of temperatures for a different one of: heating, cooling, or maintaining body temperature for a second period of time of at least 30 minutes. As such, the thermal element can be configured to provide a combination of heating, cooling, or maintaining body temperature.

At block 740, the thermal element may be controlled based at least in part on sensor feedback data, based at least in part on prior testing data correlating characteristics of the thermal element power signal to earbud tip temperature, or combination thereof.

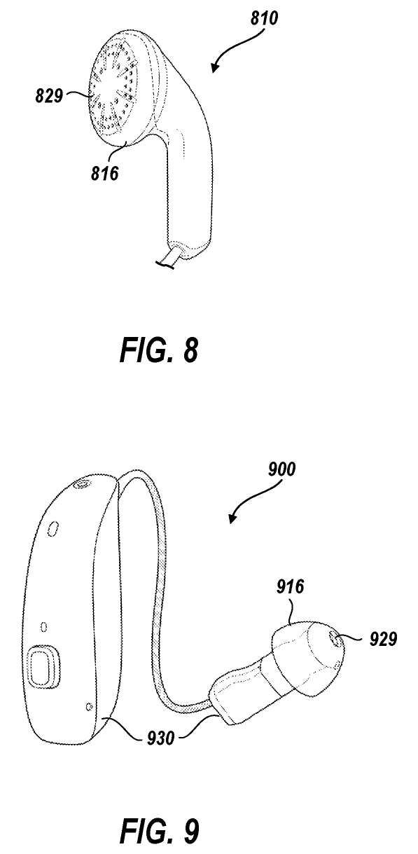

FIG. 8 is an illustration of an example earbud assembly 810 of an in-ear audio device. The earbud assembly has an intraconcha portion including an audio port 829 (as illustrated by multiple openings in the housing of the earbud assembly 810). A portion of the outer surface 816 of the intraconcha portion which can be in thermal communication with a thermal element is indicated by a dot-dash line. The earbud systems 100, 200, 300, 400, 500, 600 can be modified to include the example earbud assembly 810 illustrated in FIG. 8, variations thereof, or alternatives thereto as understood by a person skilled in the art.

FIG. 9 is an illustration of an example hearing aid 900 type audio system. The in-ear audio device of the hearing aid 900 includes an in-ear portion 910. The in-ear portion 910 includes an intracanal portion including an audio port 929 and a flexible tip 916. At least a portion of the outer surface of the flexible tip 916 can be in thermal communication with a thermal element. The hearing aid can include a control module 930 which can include circuitry for hearing aid functionality in addition to functionality of the earbuds systems and methods described herein, variations thereof, or alternatives thereto as understood by a person skilled in the art. The in-ear portion 910 can include structural features of the earbud assemblies described herein, variations thereof, or alternatives thereto as understood by a person skilled in the art.

Exemplary embodiments are described above. It is to be understood that the present invention encompasses other embodiments that are reasonable equivalents to the elements described above, as evident to a person skilled in the pertinent art.

Alternative apparatus and system features and alternative method steps are presented in example embodiments herein. Each given example embodiment presented herein can be modified to include a feature or method step presented with a different example embodiment herein where such feature or step is compatible with the given example as understood by a person skilled in the pertinent art as well as where explicitly stated herein. For instance, aspects of descriptions of earbud assemblies and earbud systems can be modified for alternative in-ear devices including hearing aids. Such modifications and variations are intended to be included within the scope of the claims.

The following clauses list non-limiting embodiments of the disclosure:

Clause 1. An audio system comprising: an in-ear audio device, comprising: an acoustic transducer, an audio port, an acoustic channel configured to deliver sound from the acoustic transducer toward the audio port, an intraconcha or intracanal portion comprising the audio port, a thermal element in thermal communication with a portion of an outer surface of the intraconcha or intracanal portion; and a control module configured to control the thermal element to control a temperature of the outer surface of the intraconcha or intracanal portion while the acoustic transducer delivers audio through the acoustic channel.

Clause 2. The audio system of clause 1, wherein the in-ear audio device comprises one and only one of: an earbud assembly comprising an intracanal portion comprising a flexible earbud tip, wherein the thermal element is in thermal communication with a portion of an outer surface of the flexible earbud tip; an earbud assembly comprising an intraconcha portion comprising a hard shell, wherein the thermal element is in thermal communication with a portion of an outer surface of the hard shell; or an in-ear portion of a hearing aid, wherein the outer surface of the intraconcha or intracanal portion of the in-ear portion of the hearing aid is in thermal communication with the thermal element.

Clause 3. The audio system of clause 1, wherein the in-ear audio device comprises an earbud assembly comprising an earbud body and a flexible earbud tip, wherein the acoustic transducer comprises a driver, wherein the earbud body contains the driver, wherein the audio port comprises an opening in the earbud body, wherein the acoustic channel comprises an audio pathway configured to deliver sound from the driver toward the opening of the earbud body, wherein the intraconcha or intracanal portion of the in-ear audio device comprises an intracanal portion of the flexible earbud tip, and wherein the thermal element is positioned in thermal communication with the intracanal portion of the flexible earbud tip.

Clause 4. The audio system of clause 3, wherein the flexible earbud tip comprises an outer contact surface forming convex surface of revolution about an axis, and wherein flexible earbud tip is configured to deform when positioned within a canal comprising a proximal funnel opening such that the outer contact surface is configured to conform to a proximal portion of the canal.

Clause 5. The audio system of clause 4, wherein the flexible earbud tip comprises a heat-conductive material selected from silicone or thermally conductive elastomers to facilitate heat transfer from the thermal element to the canal.

Clause 6. The audio system of clause 1, wherein the in-ear audio device comprises an earbud assembly comprising a rigid earbud body, wherein the acoustic transducer comprises a driver, wherein the rigid earbud body contains the driver, wherein the audio port comprises an opening in the rigid earbud body, wherein the acoustic channel comprises an audio pathway configured to deliver sound from the driver toward the opening of the rigid earbud body, wherein the intraconcha or intracanal portion of the in-ear audio device comprises an intraconcha portion of the rigid earbud body, and wherein the thermal element is positioned in thermal communication with the intraconcha portion of the rigid earbud body.

Clause 7. The audio system of clause 1, wherein the in-ear audio device comprises an in-ear portion of a hearing aid.

Clause 8. The audio system of any one of clauses 1-7, wherein the thermal element circumscribes a majority of a circumference of the acoustic channel.

Clause 9. The audio system of any one of clauses 1-8, wherein the control module is configured to control the thermal element to maintain a temperature range of the outer surface for at least an hour, the temperature range being between 35°C and 45°C.

Clause 10. The audio system of any one of clauses 1-9, comprising: a temperature sensor, wherein the control module is configured to control the thermal element based at least in part on feedback from the temperature sensor to maintain temperature of the outer surface within a defined temperature range.

Clause 11. The audio system of any one of clauses 1-10, comprising: a temperature sensor, wherein the control module is configured to generate temperature data based at least in part on measurements from the temperature sensor while the thermal element is unpowered, wherein the control module comprises a transceiver configured to communicate with a mobile device, and wherein the control module is configured to transmit the temperature data to the mobile device.

Clause 12. The audio system of any one of clauses 1-11, wherein the thermal element comprises a resistive heating element.

Clause 13. The audio system of any one of clauses 1-12, wherein the thermal element comprises a ferrous tube circumscribing the acoustic channel and an inductive coil configured to heat the ferrous tube via magnetic induction, and wherein the audio system comprises Litz wires connecting the inductive coil to the control module and configured to deliver power from the control module to the inductive coil.

Clause 14. The audio system of any one of clauses 1-13, comprising: a first power source configured to provide power to the thermal element; an audio driver circuit configured to output an electrical audio signal to the acoustic transducer; and a second power source configured to power the audio driver circuit.

Clause 15. The audio system of any one of clauses 1-14, wherein the thermal element is configured to operate with an acoustic emission level less than 30 dBA sound pressure level during audio playback.

Clause 16. The audio system of any one of clauses 1-15, wherein the control module is configured to control the thermal element to achieve a target temperature of the outer surface based at least in part on prior testing data correlating characteristics of a power signal to the thermal element to temperature of the outer surface when worn.

Clause 17. The audio system of any one of clauses 1-16, wherein the control module comprises a wireless transceiver configured to receive audio data and the control module is configured to actuate the acoustic transducer based at least in part on the audio data.

Clause 18. The audio system of any one of clauses 1-17, wherein the control module comprises a mobile phone attachment accessory configured to connect to a phone via a cable jack or wireless protocol.

Clause 19. The audio system of any one of clauses 1-18, wherein the control module comprises: a thermal element control module configured to generate a control signal for operating the thermal element; a receiver configured to receive audio data for playback by the acoustic transducer; an audio driver circuit configured to output an electrical audio signal to the acoustic transducer; a temperature control interface configured to allow a user to select a target temperature or range of temperatures; and a processor and non-transitory computer-readable medium storing instructions that, when executed by the processor, cause the thermal element control module to adjust the control signal based at least in part on the target temperature or range of temperatures while simultaneously causing the audio driver circuit to output the electrical audio signal to the acoustic transducer.

Clause 20. An earbud system comprising: a driver; an earbud body containing the driver; an audio pathway configured to deliver sound from the driver toward an opening of the earbud body; a flexible earbud tip coupled to the earbud body; a heating element positioned in thermal communication with the flexible earbud tip; and a control module configured to control the heating element to provide heat to the flexible earbud tip while the driver delivers audio through the audio pathway.

Clause 21. The earbud system of clause 20, wherein the flexible earbud tip comprises an outer contact surface forming convex surface of revolution about an axis, and wherein flexible earbud tip is configured to deform when positioned within a canal comprising a proximal funnel opening such that the outer contact surface is configured to conform to a proximal portion of the canal.

Clause 22. The earbud system of clause 21, wherein the flexible earbud tip comprises a heat-conductive material selected from silicone or thermally conductive elastomers to facilitate heat transfer from the heating element to the canal.

Clause 23. An earbud system comprising: a driver; a rigid earbud body containing the driver; an audio pathway configured to deliver sound from the driver toward an opening in the rigid earbud body; a heating element in thermal communication with a portion of the rigid earbud body; and a control module configured to control the heating element to provide heat to the portion of the rigid earbud body while the driver delivers audio through the audio pathway.

Clause 24. The earbud system of clause 23, wherein some or all of the portion of the rigid earbud body configured to be heated by the heating element is configured to be in contact with a portion of an outer ear adjacent an aperture of an ear canal when worn.

Clause 25. The earbud system of clause 23 or 24, wherein some or all of the portion of the rigid earbud body configured to be heated by the heating element comprises a heat-conductive material selected from silicone or thermally conductive elastomers to facilitate heat transfer from the heating element to an outer ear adjacent an aperture of an ear canal when worn.

Clause 26. A hearing aid comprising: an acoustic transducer; hearing-aid circuitry configured to control audio from the acoustic transducer; an audio port; an acoustic channel configured to deliver sound from the acoustic transducer toward the audio port; an in-ear portion comprising the audio port; a thermal element in thermal communication with a portion of an outer surface of the in-ear portion; and a control module configured to control the thermal element to control a temperature of the outer surface of the in-ear portion while the acoustic transducer delivers audio through the acoustic channel.

Clause 27. A control module for a heated earbud system, the control module comprising: a thermal driver circuit configured to generate a control signal for operating a thermal element of an earbud assembly; an audio driver circuit configured to output an electrical audio signal to a driver of the earbud assembly; a temperature control circuit configured to determine a target temperature or range of temperatures; and a processor and non-transitory computer-readable medium storing instructions that, when executed by the processor, cause the thermal driver circuit to adjust the control signal based at least in part on the target temperature or range of temperatures while simultaneously causing the audio driver circuit to output the electrical audio signal to the driver.

Clause 28. The control module of clause 27, comprising: a receiver circuit configured to receive audio data, wherein the audio driver circuit is configured to output the electrical audio signal based at least in part on the audio data.

Clause 29. An earbud assembly, comprising: an earbud body comprising an audio pathway; a driver housed within the earbud body and positioned to deliver sound through the audio pathway; a heating element; and a flexible earbud tip thermally coupled to the heating element via conduction and mechanically coupled to the earbud body, the flexible earbud tip comprising an outer contact surface forming convex surface of revolution about an axis such that the flexible earbud tip is configured to deform when positioned within a canal comprising a proximal funnel opening so that the outer contact surface conforms to a proximal portion of the canal.

Clause 30. The earbud assembly of clause 29, wherein the heating element and the driver are configured to be operated simultaneously.

Clause 31. The earbud assembly of clause 29 or 30, wherein the heating element circumscribes a majority of a circumference of the audio pathway, and wherein the flexible earbud tip comprises a heat-conductive material selected from silicone or thermally conductive elastomers to facilitate efficient heat transfer from the heating element to the canal.

Clause 32. A method for controlling an earbud system comprising an earbud assembly having a driver and a thermal element, the method comprising: receiving audio data; outputting an electrical audio signal to the driver based at least in part on the received audio data while simultaneously operating the thermal element; maintaining the thermal element within a target temperature or range of temperatures for an extended time period; and controlling the thermal element based at least in part on sensor feedback data and/or based at least in part on prior testing data correlating characteristics of a thermal element power signal to earbud tip temperature.

Having shown and described exemplary embodiments of the subject matter contained herein, further adaptations of the methods and systems described herein may be accomplished by appropriate modifications without departing from the scope of the claims. In addition, where methods and steps described above indicate certain events occurring in certain order, it is intended that certain steps do not have to be performed in the order described but in any order as long as the steps allow the embodiments to function for their intended purposes. Therefore, to the extent there are variations of the invention, which are within the spirit of the disclosure or equivalent to the inventions found in the claims, it is the intent that this patent will cover those variations as well. Some such modifications should be apparent to those skilled in the art. For instance, the examples, embodiments, geometrics, materials, dimensions, ratios, steps, and the like discussed above are illustrative. Accordingly, the claims should not be limited to the specific details of structure and operation set forth in the written description and drawings.

1. An earbud system comprising:
a driver;
an earbud body containing the driver;
an audio pathway configured to deliver sound from the driver toward an opening of the earbud body;
a flexible earbud tip coupled to the earbud body;
a heating element positioned in thermal communication with the flexible earbud tip; and
a control module configured to control the heating element to provide heat to the flexible earbud tip while the driver delivers audio through the audio pathway.

2. The earbud system of claim 1, wherein the heating element circumscribes a majority of a circumference of the audio pathway.

3. The earbud system of claim 1,
wherein the flexible earbud tip comprises an outer contact surface forming convex surface of revolution about an axis, and
wherein flexible earbud tip is configured to deform when positioned within a canal comprising a proximal funnel opening such that the outer contact surface is configured to conform to a proximal portion of the canal.

4. The earbud system of claim 3, wherein the flexible earbud tip comprises a heat-conductive material selected from silicone or thermally conductive elastomers to facilitate heat transfer from the heating element to the canal.

5. The earbud system of claim 1, wherein the control module is configured to control the heating element to maintain a temperature range of the flexible earbud tip for at least an hour, the temperature range being between 35°C and 45°C.

6. The earbud system of claim 1, comprising:
a temperature sensor, wherein the control module is configured to control the heating element based at least in part on feedback from the temperature sensor to maintain temperature of the flexible earbud tip within a defined temperature range.

7. The earbud system of claim 1, comprising:
a temperature sensor,
wherein the control module is configured to generate temperature data based at least in part on measurements from the temperature sensor while the heating element is unpowered,
wherein the control module comprises a transceiver configured to communicate with a mobile device, and
wherein the control module is configured to transmit the temperature data to the mobile device.

8. The earbud system of claim 1, wherein the heating element comprises a resistive heating element.

9. The earbud system of claim 1,
wherein the heating element comprises a ferrous tube circumscribing the audio pathway and an inductive coil configured to heat the ferrous tube via magnetic induction, and
wherein the earbud system comprises Litz wires connecting the inductive coil to the control module and configured to deliver power from the control module to the inductive coil.

10. The earbud system of claim 1, comprising:
a first power source configured to provide power to the heating element;
an audio driver circuit configured to output an electrical audio signal to the driver; and
a second power source configured to power the audio driver circuit.

11. The earbud system of claim 1, wherein the heating element is configured to operate with an acoustic emission level less than 30 dBA sound pressure level during audio playback.

12. The earbud system of claim 1, wherein the control module is configured to control the heating element to achieve a target temperature of the flexible earbud tip based at least in part on prior testing data correlating characteristics of a power signal to the heating element to earbud tip temperature.

13. The earbud system of claim 1, wherein the control module comprises a wireless transceiver configured to receive audio data and the control module is configured to actuate the driver based at least in part on the audio data.

14. The earbud system of claim 1, wherein the control module comprises a mobile phone attachment accessory configured to connect to a phone via a cable jack or wireless protocol.

15. The earbud system of claim 1, wherein the control module comprises:
a heating element control module configured to generate a control signal for operating the heating element;
a receiver configured to receive audio data for playback by the driver;
an audio driver circuit configured to output an electrical audio signal to the driver;
a temperature control interface configured to allow a user to select a target temperature or range of temperatures; and
a processor and non-transitory computer-readable medium storing instructions that, when executed by the processor, cause the heating element control module to adjust the control signal based at least in part on the target temperature or range of temperatures while simultaneously causing the audio driver circuit to output the electrical audio signal to the driver.

16. An earbud system comprising:
a driver;
a rigid earbud body containing the driver;
an audio pathway configured to deliver sound from the driver toward an opening in the rigid earbud body;
a heating element in thermal communication with a portion of the rigid earbud body; and
a control module configured to control the heating element to provide heat to the portion of the rigid earbud body while the driver delivers audio through the audio pathway.

17. The earbud system of claim 16, wherein some or all of the portion of the rigid earbud body configured to be heated by the heating element is configured to be in contact with a portion of an outer ear adjacent an aperture of an ear canal when worn.

18. The earbud system of claim 16, wherein some or all of the portion of the rigid earbud body is configured to be heated by the heating element and comprises a heat-conductive material to facilitate heat transfer from the heating element to an outer ear adjacent an aperture of an ear canal when worn.

19. A hearing aid comprising:
an acoustic transducer;
hearing-aid circuitry configured to control audio from the acoustic transducer;
an audio port;
an acoustic channel configured to deliver sound from the acoustic transducer toward the audio port;
an in-ear portion comprising the audio port;
a thermal element in thermal communication with a portion of an outer surface of the in-ear portion; and
a control module configured to control the thermal element to control a temperature of the outer surface of the in-ear portion while the acoustic transducer delivers audio through the acoustic channel.

20. The hearing aid of claim 19, wherein some or all of the portion of the in-ear portion comprises a heat-conductive material.
